(19) United States
(12) Patent Application Publication
(10) Pub. No.: US 2008/0225433 A1
(43) Pub. Date: Sep. 18, 2008

(54) METHOD AND APPARATUS FOR ASSEMBLING A CARRIAGE ASSEMBLY

(75) Inventors: Takayoshi MATSUMURA, Kawasaki (JP); Naoki ISHIKAWA, Kawasaki (JP); Hiroshi KOBAYASHI, Kawasaki (JP); Hidehiko KIRA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/128,985

(22) Filed: May 29, 2008

Related U.S. Application Data
(63) Continuation of application No. PCT/JP2005/022098, filed on Dec. 1, 2005.

(51) Int. Cl. G11B 5/012

(52) U.S. Cl. 360/97.01

(57) ABSTRACT

A method and apparatus for assembling a carriage assembly attach suspensions to carriage arms without deformation and with higher accuracy than with the conventional art.

Suspensions are placed on carriage arms by aligning engagement holes 10a provided in the carriage arms and spacer holes provided in spacer portions of the suspension. A bar-shaped operation member whose outer diameter is equal to or smaller than the inner diameter of the spacer holes is inserted into the spacer holes and longitudinal ultrasonic vibration is applied to the bar-shaped operation member to cause expanding and contracting motion in the radial direction of the spacer hole, so that when the diameter of the operation member expands, the operation member contacts edge portions of the spacer holes of the spacer portions and crimps the edge portions to fix the suspensions to the carriage arms.

### TECHNICAL FIELD

The present invention relates to a method of assembling a carriage assembly assembled by attaching a suspension of a magnetic disk apparatus to a front end portion of a carriage arm, and to an assembling apparatus that uses such method.

### BACKGROUND ART

FIG. 4 is a view showing the external appearance of a carriage assembly used in a magnetic disk apparatus. In FIG. 4, reference numeral 10 designates carriage arms, and reference numeral 12 designates one example of a suspension that is attached to a front end portion of a carriage arm 10. A magnetic head 14 is mounted on a front end portion of each suspension 12. Such magnetic heads 14 are electrically connected to a control unit 18 via a flexible substrate 16 attached to side surfaces of the carriage arms 10. Reference numeral 19 designates an actuator shaft to which the respective base portions of the carriage arms 10 are fixed. The carriage arms 10 carry out seek operations on planes that are parallel to the surfaces of recording media by rotating the actuator shaft 19 about its axis.

The carriage assembly is formed by fixing each suspension 12 by crimping to both surfaces of the front end portion of one out of the carriage arms 10 that have been attached to the actuator shaft 19 so as to be parallel to one another.

A conventional method of fixing the suspensions 12 to the carriage arms 10 is disclosed by Patent Document 1. FIG. 5 shows the conventional method of fixing the suspensions 12 to the carriage arms 10 disclosed by Patent Document 1.

According to this conventional method, after the suspensions 12 have been aligned with and placed on the front ends of the respective carriage arms 10, an ultrasonic horn 32 equipped with an operation portion 30 formed with a maximum outer diameter that is slightly larger than an inner diameter of spacer holes 12b of the suspensions 12 is used, and while applying ultrasonic vibration from a vibrator 34, the operation portion 30 and the ultrasonic horn 32 are passed through the spacer holes 12b to fix the suspensions 12 to the carriage arms 10 by crimping the edge portions of the spacer holes 12b using the outer surface of the operation portion 30.

FIG. 6 shows how the operation portion 30 is passed through the spacer holes 12b of the suspensions 12 to fix the suspensions 12 to the carriage arms 10 by crimping. The suspensions 12 are placed on both surfaces of the respective carriage arms 10 with the spacer holes 12b aligned with engagement holes 10a. Since the operation portion 30 (30a and 30b) is formed with a slightly larger diameter than the spacer holes 12b, when the operation portion 30 is passed through the spacer holes 12b, the operation portion 30 acts so as to press open the crimping portions 13 formed at the inner circumferential edges of the spacer holes 12b so that the suspensions 12 are fixed so as to “bite” into the carriage arms 10. As shown in FIG. 6, during one crimping operation, the operation portion 30 is moved so as to successively pass through the spacer holes 12b together with the ultrasonic horn 32 from one side of the carriage arms 10 to the other.

### Patent Document 1

Japanese Laid-Open Patent Publication No. 2004-127491 (See Paragraphs 0012 to 0014 and 0016 to 0017, and FIGS. 1, 2, and 4)

### DISCLOSURE OF THE INVENTION

In this way, when assembling a carriage assembly, an operation portion 30 with an outer diameter that is larger than the inner diameter of the spacer holes 12b is moved in one direction inside the spacer holes 12b to cause the crimping portions 13 to deform and thereby fix the suspensions 12 to the carriage arms 10 by crimping. Accordingly, since the spacer portions 12a deform due to the stress that acts on the spacer portions 12a during crimping, there can be a drop in the flatness of the spacer portions 12a. If there is a drop in the flatness of the spacer portions 12a, the suspensions 12 that extend from the spacer portions 12a become tilted from the standard angles. Such tilting of the suspension 12 affects the float height of the magnetic head 14 above the surface of a recording medium and leads to the problem of fluctuation in the float height of the magnetic head 14 above the surface of the recording medium.

Modern magnetic disk apparatuses now have an extremely large storage capacity, leading to increasing restrictions on the float height of a magnetic head from the surface of a recording medium. Fluctuations in the float height of the magnetic head have a large effect on the information read/write characteristics, and therefore to achieve the desired characteristics, there is demand to suppress fluctuations in the float height of the magnetic head.

The present invention was conceived to solve the problem described above and it is an object of the present invention to provide a method of assembling a carriage assembly that can attach suspensions to carriage arms without deformation and with higher accuracy than in the conventional art, and can therefore suppress fluctuations in the float characteristics of magnetic heads and assemble a carriage assembly with favorable information read/write characteristics.

By conducting thorough research to solve the problem described above, the inventor of the present application discovered that the spacer portions deform in the conventional method of assembling a carriage assembly due to the mechanism described below.

In the conventional method described above, since an operating portion with a larger outer diameter than the inner diameter of the spacer holes is moved in one direction inside the spacer holes, each crimping portion is subjected to not only a force that presses open the crimping portion but also a force in the direction in which the operating portion is moving, that is, a direction that is perpendicular to the plane of each spacer portion (in other words, from one surface to the other surface of each spacer portion). This force that is perpendicular to the plane of the spacer portion is believed to slightly bend the spacer portion and cause a drop in the flatness of the spacer portion.

For this reason, to achieve the object described above, a method of assembling a carriage assembly according to the present invention has the following construction.

A method of assembling a carriage assembly where a suspension of a magnetic disk apparatus is attached to a front end portion of a carriage arm includes steps of: placing the suspension on the carriage arm with an engagement hole provided in the carriage arm aligned with a spacer hole provided in a spacer portion of the suspension; inserting a bar-shaped operation member whose outer diameter is equal to or smaller than an inner diameter of the spacer hole into the spacer hole; and applying longitudinal ultrasonic vibration to the bar-shaped operation member to cause expanding and contracting motion in a radial direction of the spacer hole, so that when a diameter of the operation member expands, the operation member contacts an edge portion of the spacer hole of the spacer portion and crimps the edge portion to fix the suspension to the carriage arm.

With this construction, longitudinal ultrasonic vibration is applied to an operation member inserted into a spacer hole and the expanding and contracting motion in the diameter direction of the operation member is used to crimp the edge portion of the spacer hole. This means that the operation member applies only a force that presses open the crimping portion to the crimping portion of the spacer portion, and no force acts in a direction perpendicular to the plane of the spacer portion (that is, a direction from one surface to the other surface of the spacer portion, or in other words, the axial direction of the spacer hole). Accordingly, it is possible to solve the problem with the conventional art of the spacer portion bending, resulting in a drop in flatness.

In addition, the ultrasonic vibration of the operation member may be stationary wave vibration, and the carriage arm and the operation member may be positioned relative to one another so that a nodal point of the ultrasonic vibration of the operation member coincides with the edge portion of the spacer hole.

By doing so, it is possible to efficiently carry out crimping using nodal points where the diameter of the operation member that is ultrasonically vibrating expands by the maximum amount.

A plurality of the carriage arms may be provided in parallel at equal intervals and the engagement holes formed in the plurality of carriage arms may be disposed so that center axes thereof are aligned on the same axis, the ultrasonic vibration of the operation member may be set so that a half-wavelength thereof is equal to a value produced by dividing the interval between the plurality of carriage arms by a natural number, a suspension may be attached to each of the plurality of carriage arms, the operation member may be inserted so as to pass through the spacer holes of the respective suspensions and the carriage arms and the operation member may be positioned relative to one another so that nodal points coincide with the edge portion of each spacer hole, and ultrasonic vibration may be applied to the operation member to crimp the edge portions of the spacer holes to fix the suspensions to the carriage arms.

By doing so, it is possible to simultaneously fix a plurality of suspensions to a plurality of carriage arms of a carriage assembly by crimping.

Also, to achieve the object described above, an assembling apparatus for a carriage assembly according to the present invention has the following construction.

An assembling apparatus uses a method of assembling a carriage assembly where a suspension is attached to a front end portion of a carriage arm used in a magnetic disk apparatus by placing the suspension on the carriage arm with an engagement hole provided in the carriage arm aligned with a spacer hole provided in a spacer portion of the suspension and crimping an edge portion of the spacer hole of the spacer portion, the assembling apparatus including: a bar-shaped operation member formed with an outer diameter that is equal to or smaller than an inner diameter of the spacer hole; a driving apparatus that moves and controls the bar-shaped operation member so that the operation member is inserted into the spacer hole; and ultrasonic vibration means for applying longitudinal ultrasonic vibration to the bar-shaped operation member inserted into the spacer hole, wherein the ultrasonic vibration means applies longitudinal ultrasonic vibration to the bar-shaped member to cause expanding and contracting motion in a radial direction of the spacer hole so that when a diameter of the operation member expands, the operation member contacts an edge portion of the spacer hole of the spacer portion and crimps the edge portion to fix the suspension to the carriage arm.

With this construction, longitudinal ultrasonic vibration is applied to an operation member inserted into a spacer hole and the expanding and contracting motion in the diameter direction of the operation member is used to crimp the edge portion of the spacer hole. This means that the operation member applies only a force that presses open the crimping portion to the crimping portion of the spacer portion and no force acts in a direction perpendicular to the plane of the spacer portion (that is, a direction from one surface to the other surface of the spacer portion, or in other words, the axial direction of the spacer hole). Accordingly, it is possible to solve the problem with the conventional art of the spacer portions bending, resulting in a drop in flatness.

In addition, the ultrasonic vibration of the operation member applied by the ultrasonic vibration means may be stationary wave vibration, and the driving apparatus may position the carriage arm and the operation member relative to one another so that a nodal point of the ultrasonic vibration of the operation member coincides with the edge portion of the spacer hole.

By doing so, it is possible to efficiently carry out crimping using nodal points where the diameter of the operation member that is ultrasonically vibrating expands by the maximum amount.

Also, the carriage assembly to be assembled may include a plurality of the carriage arms provided in parallel at constant intervals and the engagement holes formed in the plurality of carriage arms may be disposed so that center axes thereof are aligned on the same axis, the ultrasonic vibration applied to the operation member by the ultrasonic vibration means may be set so that a half-wavelength thereof is equal to a value produced by dividing the interval between the plurality of carriage arms by a natural number, the driving apparatus may insert the operation member so as to pass through the spacer holes of the respective suspensions and position the carriage arms and the operation member relative to one another so that the nodal points coincide with the edge portion of each spacer hole, and the ultrasonic vibration means may apply the ultrasonic vibration to the operation member that has been positioned to crimp the edge portions of the spacer holes to fix the suspensions to the carriage arms.

By doing so, it is possible to simultaneously fix a plurality of suspensions to a plurality of carriage arms of a carriage assembly by crimping.

### EFFECT OF THE INVENTION

According to the method of assembling and assembling apparatus for a carriage assembly according to the present invention, since it is possible to suppress deformation of the spacer portions of suspensions and maintain favorable flatness, it is possible to attach suspensions to the carriage arms without tilting and with higher accuracy than with the conventional art, to suppress fluctuations in the float characteristics of magnetic heads by doing so, and to assemble a carriage assembly with favorable information read/write characteristics.

### BRIEF DESCRIPTION OF THE DRAWINGS

FIG. 1 is a diagram useful in explaining a method of assembling and an assembling apparatus for a carriage assembly according to the present invention;

FIGS. 2A to 2D are diagrams useful in explaining how an operation member (shaft) deforms when ultrasonic vibration is applied to the operation member to produce a longitudinal stationary wave;

FIG. 3 is a diagram showing how the operation member (shaft) deforms when ultrasonic vibration is applied to the operation member;

FIG. 4 is a diagram useful in explaining the overall construction of a carriage assembly;

FIG. 5 is a diagram useful in explaining a conventional method of assembling a carriage assembly; and

FIG. 6 is a diagram useful in explaining a conventional method of assembling a carriage assembly.

### BEST MODE FOR CARRYING OUT THE INVENTION

Preferred embodiments of the present invention will now be described in detail with reference to the attached drawings.

The carriage assembly to be assembled by the method of assembling a carriage assembly and assembling apparatus according to the present embodiment is shown in FIG. 4. Since the fundamental construction of the carriage assembly shown in FIG. 4 was described in the Background Art, description thereof is omitted here. In this carriage assembly, a plurality of carriage arms 10 are provided in parallel at equal intervals, and engagement holes 10a formed in the plurality of carriage arms 10 are disposed in a line so that the respective center axes of the engagement holes 10a are aligned on the same axis.

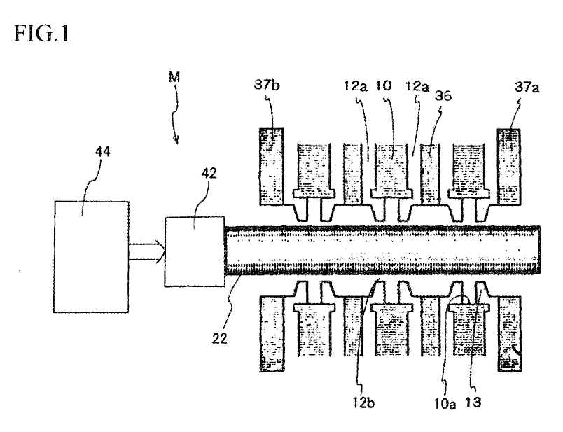

FIG. 1 is a diagram useful in explaining a method of assembling a carriage assembly according to the present embodiment. In FIG. 1, the shapes of the carriage arms 10 and the suspensions 12 are no different to the background art described above. That is, the engagement holes 10a are provided at the front ends of the carriage arms 10 and the spacer holes 12b that are fitted into the engagement holes 10a are formed in the spacer portions 12a provided at the base portions of the suspensions 12.

As shown in FIG. 1, an assembling apparatus M used by the method of assembling a carriage assembly according to the present embodiment includes a shaft 22 as an operation member, an ultrasonic vibrating apparatus 42 as an ultrasonic vibrating means that applies ultrasonic vibration to the shaft 22, and a driving apparatus 44 capable of moving and controlling the shaft 22.

The shaft 22 is formed in the shape of a cylindrical bar with an outer diameter that is slightly smaller than the inner diameter of the spacer holes 12b.

The shaft 22 is formed of iron or an alloy that includes iron. Note that the material of the shaft 22 is not limited to such and that it is also possible to use a metal or alloy including titanium, stainless steel, or the like, or to use ceramics or the like.

The ultrasonic vibrating apparatus 42 is capable of applying longitudinal ultrasonic vibration to the shaft 22 from one end of the shaft 22. The frequency F of the ultrasonic vibration is set so as to satisfy an equation F=NV/2P where P is the interval between the spacer holes 12b (the engagement holes 10a), V is the speed at which the ultrasonic vibration travels through the shaft 22 (i.e., the speed at which sound travels through the shaft 22, which is uniquely determined by the material of the shaft 22), and N is an arbitrary natural number. In the assembling apparatus M for a carriage assembly, various conditions such as the length of the shaft 22 are set so that ultrasonic vibration of the frequency F forms a stationary wave on the shaft 22.

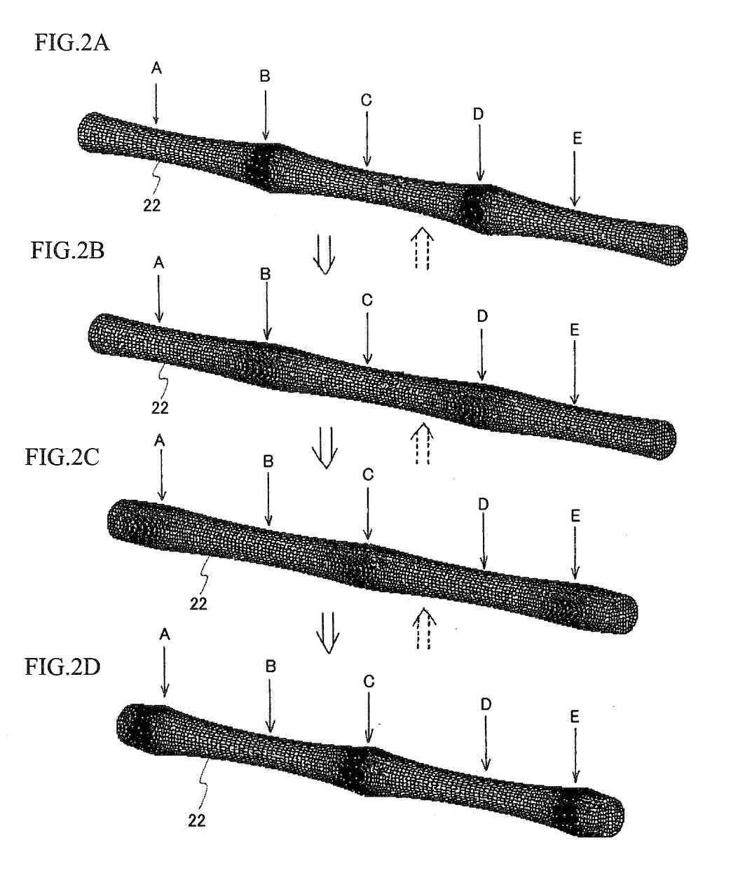

FIG. 2 is a diagram useful in explaining how the shaft 22 deforms when ultrasonic vibration is applied to the shaft 22 so as to form a longitudinal stationary wave (note that for ease of understanding, the deformation in the radial direction of the shaft 22 is shown larger than in real life in FIG. 2). The shaft 22 to which the ultrasonic vibration has been applied cyclically deforms in a time series represented by FIG. 2A→2B→2C→2D→2C→2B→2A→2B . . . . In FIGS. 2A to 2D, the points labeled A to E are nodal points in the longitudinal ultrasonic vibration. The intervals between the nodal points A to E are equal to half the wavelength of the ultrasonic vibration that travels through the shaft 22. At the nodal points A to E, no amplitude is produced in the axial direction of the shaft 22 due to the antagonism between the forces of compression and tension that accompany vibration of the material before and after the nodal points, but due to the compression and tension that accompany the longitudinal vibration, the material is pushed and pulled in the radial direction, resulting in expanding and contracting motion of the radius of the shaft 22.

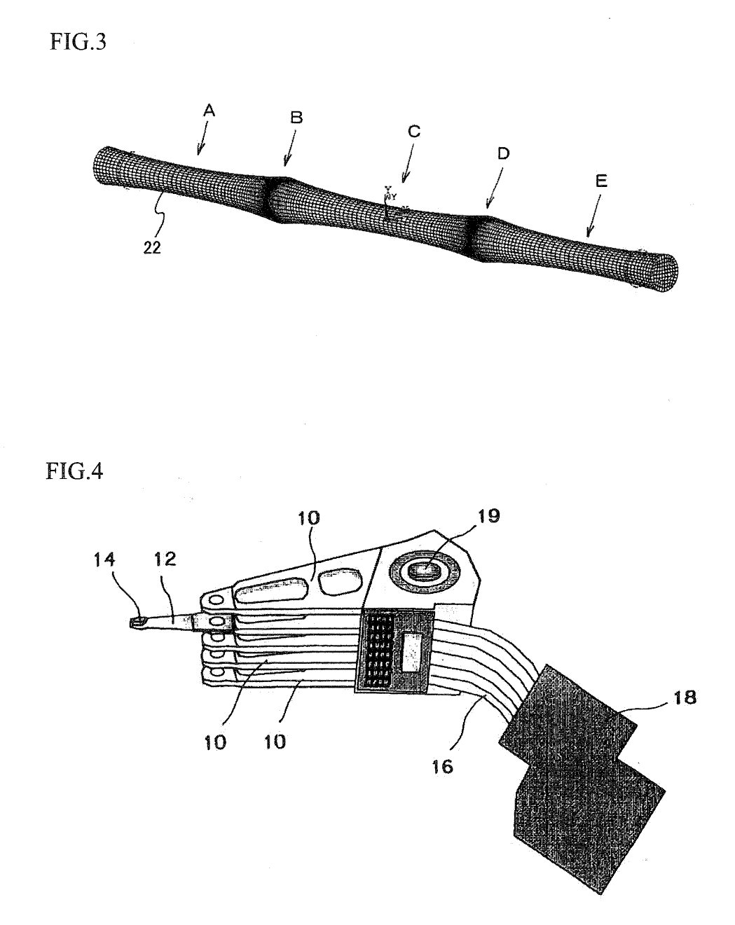

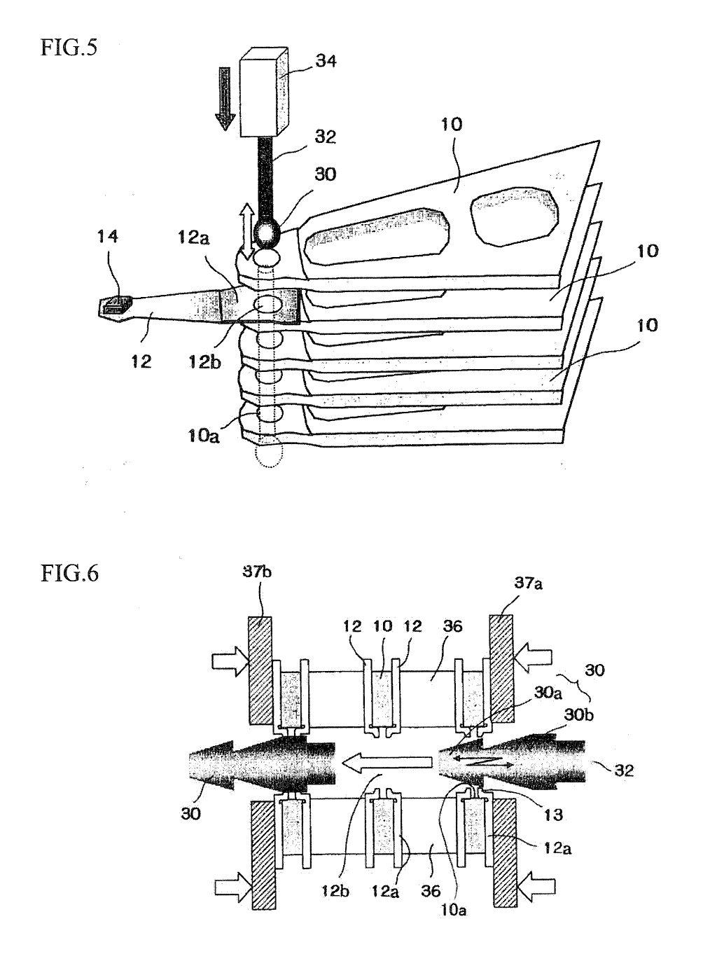

FIG. 3 is a diagram useful in explaining a computer simulation of the form of the shaft 22 when the deformation due to the expanding and contracting motion at the nodal points A to E is maximum, for conditions where ultrasonic vibration for forming a longitudinal stationary wave with a wavelength of 32 mm (that is, a frequency of 160 kHz) is applied to the shaft 22 which is formed of a cylinder that is 80 mm long and 4 mm in diameter and is made of an iron material in which sound travels at 5120 m/s (in the computer simulation shown in FIG. 3, the amount of deformation in the radial direction of the shaft 22 is drawn larger than in real life). In these conditions, the amount of deformation in the radial direction (i.e., the amount by which the diameter expands and contracts) of the shaft 22 at the nodal points A to E is substantially equal to the amplitude in the axial direction of the applied ultrasonic vibration. For example, when the amplitude of the ultrasonic vibration is set at 10 μm, the diameter will also expand and contract in a range of substantially 10 μm. That is, at the nodal points A to E of the shaft 22 with a diameter of 4 mm, the diameter of the shaft 22 will move so as to expand and contract within a range of substantially (4 mm-10 μm) to (4 mm+10 μm).

The method of assembling a carriage assembly according to the present embodiment is characterized by using deforming motion, whereby the operation member expands and contracts when longitudinal ultrasonic vibration is applied to the operation member, to crimp and fix the suspensions to the carriage arms.

The procedure of a preferred embodiment of a method of assembling a carriage assembly according to the present invention will now be described.

When the suspensions 12 are placed on the carriage arms 10, first the suspensions 12 are assembled on the front ends of the respective arms out of a plurality of carriage arms 10 by aligning the spacer holes 12b with the engagement holes 10a.

Next, as shown in FIG. 1, the shaft 22 is moved and controlled by the driving apparatus 44 so that the shaft 22 is inserted through the spacer holes 12b. When doing so, the shaft 22 is inserted so as to pass through the spacer holes 12b of the suspensions 12 and the shaft 22 is positioned relative to the carriage arms 10 so that the nodal points of the shaft 22 coincide with the edge portions (i.e., the crimping portions 13) of the spacer holes 12b.

For example, when assembling a carriage assembly where the intervals between the three carriage arms 10 (that is, the intervals between the spacer holes 12b and the engagement holes 10a) are 32 mm, the ultrasonic vibration is set so that the half wavelength thereof is equal to a value produced by dividing the 32 mm interval by a natural number, the nodal point positions of the shaft 22 when such ultrasonic vibration is applied are calculated in advance, and the shaft 22 is positioned so that the positions in the axial direction of the nodal points and the edge portions of the spacer holes coincide. In the example shown in FIG. 2, if, for example, the half-wavelength is set at 16 mm that is half of the interval between the spacer holes 12b (the engagement holes 10a) or in other words, the wavelength is set at 32 mm, since the nodal points A to E in FIGS. 2A to 2D will be positioned at intervals of the half-wavelength, i.e., 16 mm, the shaft 22 should be positioned so that the positions in the axial direction of every other nodal point A, C, E out of the nodal points A to E coincide with the spacer hole edge portions (i.e., the crimping portions 13).

By applying the ultrasonic vibration to the shaft 22 using the ultrasonic vibrating apparatus 42 in a state where the shaft 22 has been positioned as described above, expanding and contracting motion of the shaft 22 is caused so that the nodal points contact the crimping portions 13 at the edge portions of the spacer holes to crimp the edge portions and thereby fix the suspensions 12 to the carriage arms 10.

Note that in FIG. 1, to further suppress deformation of the spacer portions 12a that occurs when the suspensions 12 are fixed to the carriage arms 10, the assembling apparatus M for assembling a carriage assembly is used to fix the suspensions 12 to the carriage arms 10 in a state where interval maintaining plates 36 have been inserted between adjacent carriage arms 10 and where both outer end surfaces of the aligned carriage arms 10 have been sandwiched between pressure applying plates 37a, 37b. The pressure applying plates 37a, 37b are supported from both sides using a support jig and are caused by a pressing mechanism to apply a pressing force to the fixed portions of the carriage arm 10 and the suspension 12. The interval maintaining plates 36 are set by being inserted between adjacent carriage arms 10 using an interval maintaining plate inserting mechanism.

The pressure applying plates 37a, 37b and the interval maintaining plates 36 are removed from the carriage assembly when the crimping process using the assembling apparatus M for a carriage assembly has been completed.

During the crimping process, by pressing the spacer portions 12a via the interval maintaining plates 36 using the pressure applying plates 37a, 37b, it is possible to fix the suspensions 12 to the carriage arms 10 while suppressing deformation of the spacer portions 12a and the suspensions 12.

According to the method of assembling and assembling apparatus for a carriage assembly according to the present embodiment, after the shaft 22 has been inserted into the spacer holes 12b, ultrasonic vibration is applied to the shaft 22 to cause the expanding and contracting motion described above and crimp the edge portions of the spacer holes 12b (the crimping portions 13). This means that the shaft 22 contacts the crimping portions 13 and applies a force that presses open the crimping portions 13, but no force acts in a direction that is perpendicular to the planes of the spacer portions 12a (i.e., a direction from one surface to the other surface of each spacer portion 12a), so that it is possible to solve the conventional problem of the spacer portions 12a bending and causing a drop in flatness.

By doing so, since it is possible to suppress deformation in the spacer portions 12a of the suspensions 12 and keep the spacer portions 12a highly flat, the suspensions 12 can be attached to the carriage arms 10 without tilting and with higher accuracy than with the conventional art. By doing so, it is possible to assemble a carriage assembly with suppressed fluctuations in the float characteristics of the magnetic heads 14 and with favorable information read/write characteristics.

Note that although the half-wavelength of the ultrasonic vibration is set at half (16 mm) of the interval (32 mm) between the plurality of carriage arms 10 in the present embodiment, the present invention is not limited to such. The present invention includes all conditions where the half-wavelength of the ultrasonic vibration is set at a value produced by dividing the interval between the plurality of carriage arms by a natural number, that is, where the equation F=NV/2P described earlier is satisfied. Also, although an example where N=2 is described in the present embodiment, it is also possible to position predetermined nodal points at the edge portions of the spacer holes even when N=1, that is, when the half-wavelength of the ultrasonic vibration is set equal to the interval between the carriage arms, or when N>2, that is, when a plurality of nodal points are present between the crimping portions 13.

In addition, although the present embodiment is constructed so that the nodal points contact the edge portions of the spacer holes, the present invention is not limited to this and it is still possible to carry out crimping even at positions that are displaced from the nodal points where expanding and contracting motion of the operation member occurs, albeit not as greatly as the expanding and contracting motion at the nodal points. Also, although the ultrasonic vibration that travels through the operation member is set so as to form a stationary wave in the present embodiment, the present invention is not limited to such and also includes constructions where expanding and contracting motion of a traveling wave is used for crimping.

What is claimed is:

1. A method of assembling a carriage assembly where a suspension of a magnetic disk apparatus is attached to a front end portion of a carriage arm, the method comprising steps of:
placing the suspension on the carriage arm with an engagement hole provided in the carriage arm aligned with a spacer hole provided in a spacer portion of the suspension;
inserting a bar-shaped operation member whose outer diameter is equal to or smaller than an inner diameter of the spacer hole into the spacer hole; and
applying longitudinal ultrasonic vibration to the bar-shaped operation member to cause expanding and contracting motion in a radial direction of the spacer hole, so that when a diameter of the operation member expands, the operation member contacts an edge portion of the spacer hole of the spacer portion and crimps the edge portion to fix the suspension to the carriage arm.

2. A method of assembling a carriage assembly according to claim 1,
wherein the ultrasonic vibration of the operation member is stationary wave vibration, and
the carriage arm and the operation member are positioned relative to one another so that a nodal point of the ultrasonic vibration of the operation member coincides with the edge portion of the spacer hole.

3. A method of assembling a carriage assembly according to claim 2,
wherein a plurality of the carriage arms are provided in parallel at equal intervals and the engagement holes formed in the plurality of carriage arms are disposed so that center axes thereof are aligned on the same axis,
the ultrasonic vibration of the operation member is set so that a half-wavelength thereof is equal to a value produced by dividing the interval between the plurality of carriage arms by a natural number,
a suspension is attached to each of the plurality of carriage arms,
the operation member is inserted so as to pass through the spacer holes of the respective suspensions, and the carriage arms and the operation member are positioned relative to one another so that nodal points coincide with the edge portion of each spacer hole, and
ultrasonic vibration is applied to the operation member to crimp the edge portions of the spacer holes to fix the suspensions to the carriage arms.

4. An assembling apparatus that uses a method of assembling a carriage assembly where a suspension is attached to a front end portion of a carriage arm used in a magnetic disk apparatus by placing the suspension on the carriage arm with an engagement hole provided in the carriage arm aligned with a spacer hole provided in a spacer portion of the suspension and crimping an edge portion of the spacer hole of the spacer portion,
the assembling apparatus comprising:
a bar-shaped operation member formed with an outer diameter that is equal to or smaller than an inner diameter of the spacer hole;
a driving apparatus that moves and controls the bar-shaped operation member so that the operation member is inserted into the spacer hole; and
ultrasonic vibration means for applying longitudinal ultrasonic vibration to the bar-shaped operation member inserted into the spacer hole,
wherein the ultrasonic vibration means applies longitudinal ultrasonic vibration to the bar-shaped member to cause expanding and contracting motion in a radial direction of the spacer hole so that when a diameter of the operation member expands, the operation member contacts an edge portion of the spacer hole of the spacer portion and crimps the edge portion to fix the suspension to the carriage arm.

5. An assembling apparatus according to claim 4,
wherein the ultrasonic vibration of the operation member applied by the ultrasonic vibration means is stationary wave vibration, and
the driving apparatus positions the carriage arm and the operation member relative to one another so that a nodal point of the ultrasonic vibration of the operation member coincides with the edge portion of the spacer hole.

6. An assembling apparatus according to claim 5,
wherein the carriage assembly to be assembled includes a plurality of the carriage arms provided in parallel at constant intervals, and the engagement holes formed in the plurality of carriage arms are disposed so that center axes thereof are aligned on the same axis,
the ultrasonic vibration applied to the operation member by the ultrasonic vibration means is set so that a half-wavelength thereof is equal to a value produced by dividing the interval between the plurality of carriage arms by a natural number,
the driving apparatus inserts the operation member so as to pass through the spacer holes of the respective suspensions and positions the carriage arms and the operation member relative to one another so that the nodal points coincide with the edge portion of each spacer hole, and
the ultrasonic vibration means applies the ultrasonic vibration to the operation member that has been positioned to crimp the edge portions of the spacer holes to fix the suspensions to the carriage arms.
